(19) United States
(12) Patent Application Publication
(10) Pub. No.: US 2014/0290120 A1
(43) Pub. Date: Oct. 2, 2014

(54) DOUBLE HOOK FISHING DEVICE

(71) Applicant: Michael Todd Kinna, Carrollton, GA (US)

(72) Inventor: Michael Todd Kinna, Carrollton, GA (US)

(21) Appl. No.: 13/851,870

(22) Filed: Mar. 27, 2013

(51) Int. Cl. A01K 83/00

(52) U.S. Cl. CPC A01K 83/00
USPC 43/43.16

(57) ABSTRACT

A fish catching device of the present invention is a fishing hook with two hooks. The double hook allows for more than one bait choice and increased movement, thus allowing for a better fish catch. The multiple bait choices may further attract different fish and thereby more fish at one time. The hooks may be substantially parallel to one another.

### BACKGROUND OF THE INVENTION

The present invention relates to a device used for fishing and, more particularly, to a double fishing hook.

Currently, a single fish hook may be used to catch fish. However, the single fish hook may only hold one bait at a time, limiting the bait choices and thereby limiting a user's catch.

As can be seen, there is a need for a hook that may carry multiple baits at a time.

### SUMMARY OF THE INVENTION

In one aspect of the present invention, a fishing hook device comprises: a rail comprising a first side rail and a second side rail; a first hook connected to the first side rail; and a second hook connected to the second side rail, wherein the first hook and the second hook are substantially parallel to one another.

These and other features, aspects and advantages of the present invention will become better understood with reference to the following drawings, description and claims.

### BRIEF DESCRIPTION OF THE DRAWINGS

FIG. 1 is a perspective view of the present invention, shown in use;

FIG. 2 is a perspective view of the present invention;

FIG. 3 is a front view of the present invention;

FIG. 4 is a side view of the present invention;

FIG. 5 is a top view of the present invention;

FIG. 6 is an exploded view of the present invention, with exemplary bait;

FIG. 7 is a perspective view of an alternate embodiment of the present invention; and

FIG. 8 is a front view of an alternate embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a fish catching device including a fishing hook with two hooks. The double hook allows for more than one bait choice and increased movement, thus allowing for a better fish catch. The multiple bait choices may further attract different fish and thereby more fish at one time. The hooks may be substantially parallel to one another.

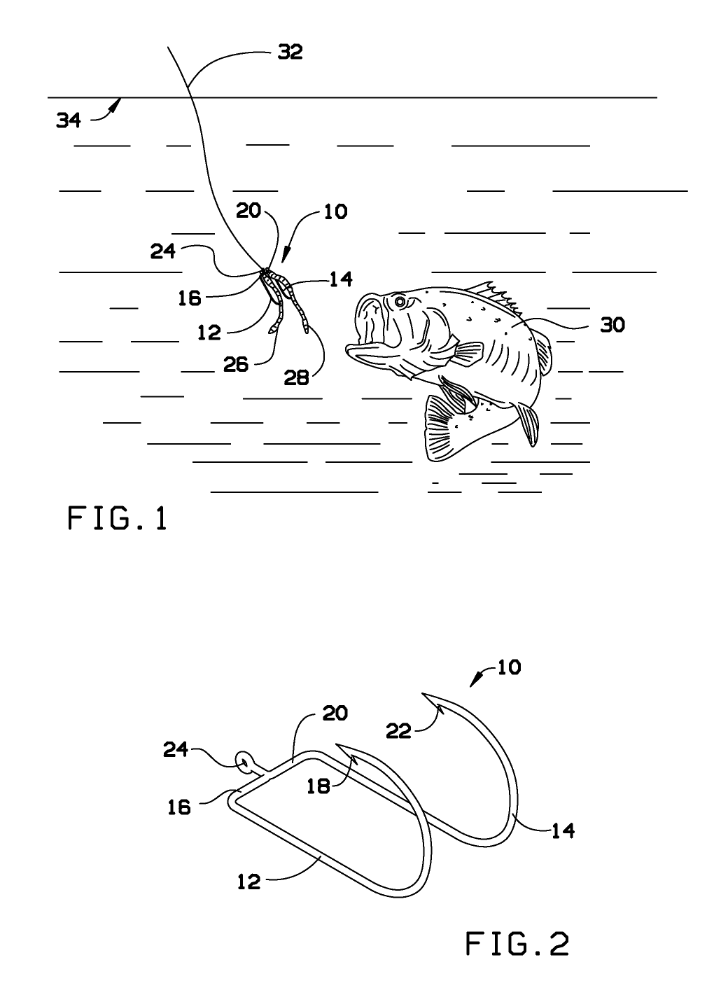

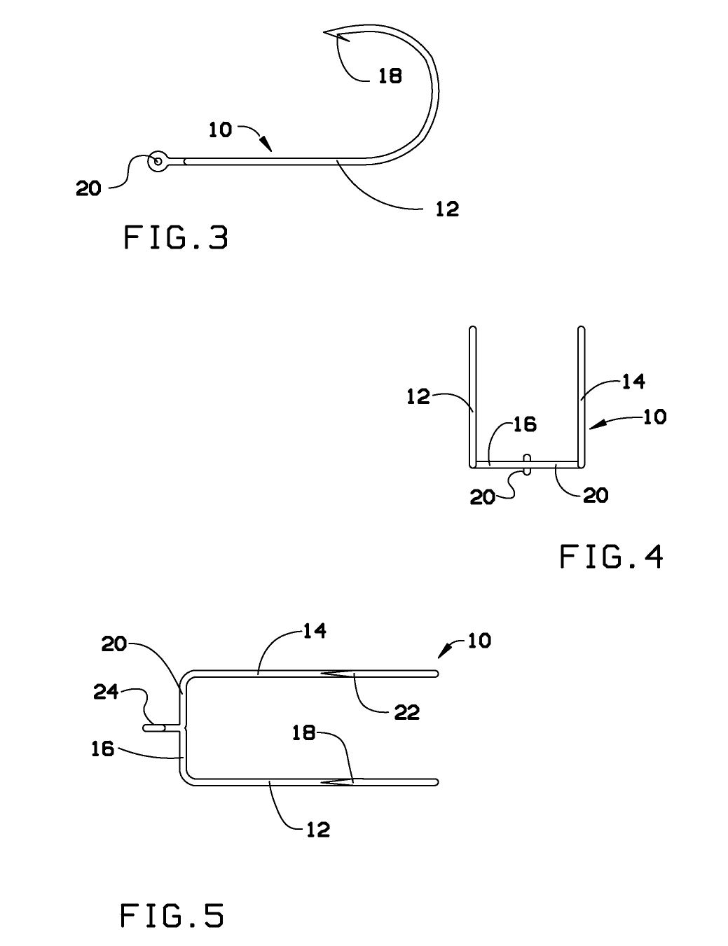

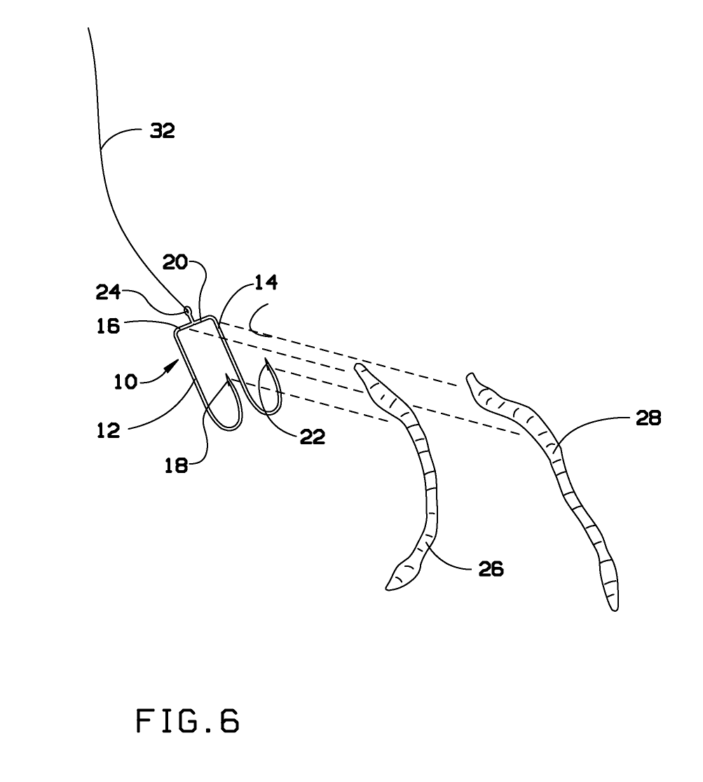

Referring now to FIGS. 1 through 8, the present invention may include a double fish hook 10. The double fish hook 10 may include a first hook 12 and a second hook 14. In certain embodiments, the first hook 12 may include a first barb 18 and the second hook 14 may include a second barb 22. The first hook 12 and the second hook 14 may be connected together by a rail. The rail may support the first hook 12 and the second hook 14. For example, the rail may include a first side rail 16 supporting the first hook 12, and a second side rail 20 supporting the second hook 14. An eye 24 may be connected to the top of the rail so that a fishing line 32 may be secured to the double fish hook 10.

The double fish hook 10 of the present invention may include a first hook 10 and a second hook 12 that are substantially parallel to one another. In certain embodiments, the first hook 12 and the second hook 14 may be greater than about ⅜ of an inch apart. For example, the first hook 12 and the second hook 14 may be about 6/8 of an inch apart, and in certain embodiments, may be about an inch apart. In certain embodiments, the first hook 12 and the second hook 14 may be about 1 and ½ of an inch or 1 and ¾ of an inch in length and may each include a bend that may be about 15/16 of an inch. The eye 24 may be projecting upward about ⅛ of an inch from the rail. The present invention is not limited to the dimensions listed and may have similar dimensions to fishing hooks in the art.

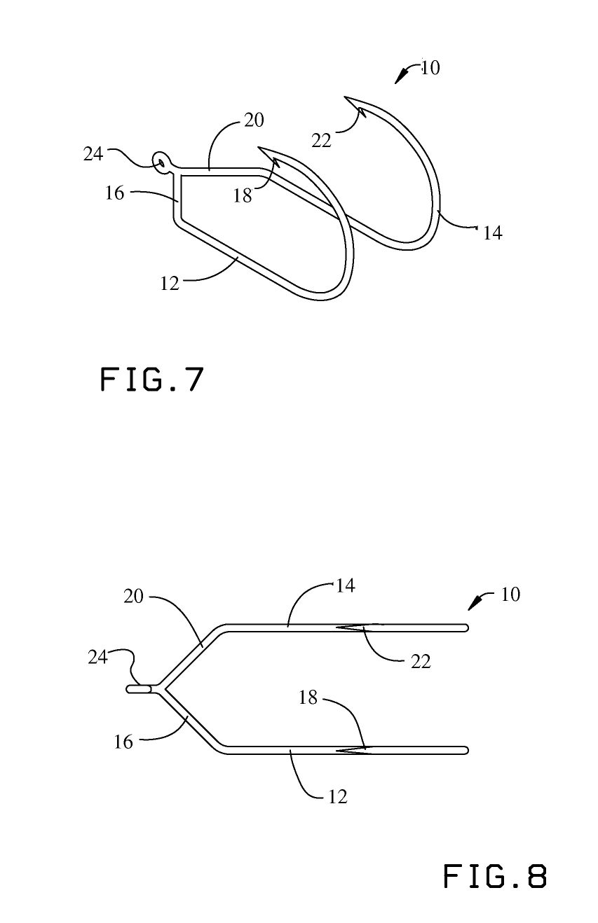

In certain embodiments, the rail may be substantially straight, as illustrated in FIGS. 1 through 6. In such embodiments, the first hook 12 and the second hook 14 may be at about a right angle relative to the rail. In certain embodiments, the rail may include a bend where the first side rail 16 and the second side rail 20 meet, as illustrated in FIGS. 7 and 8. The bend may be from about a 30 degree angle and up to about 160 degrees. For example, the bend may be about 90 degrees.

A method of using the following device may include the following. A user may attach the fishing line 32 to the eye 24 of the double fish hook 10. The user may then attach a first bait 26 to the first hook 12 and a second bait 28 to the second hook 14. For example, a user may use two different colored worms to attract different fish 30. The user may then cast to baited double fish hook 10 into a body of water 34 to begin fishing. With the two different baits 26, 28 attached to the hooks 12, 14 more fish 30 may be attracted than only one hook with one bait.

It should be understood, of course, that the foregoing relates to exemplary embodiments of the invention and that modifications may be made without departing from the spirit and scope of the invention as set forth in the following claims.

What is claimed is:

1. A fishing hook device comprising:
a rail comprising a first side rail and a second side rail;
a first hook connected to the first side rail; and
a second hook connected to the second side rail,
wherein the first hook and the second hook are substantially parallel to one another.

2. The fishing hook device of claim 1, further comprising an eye connected to a top of the rail.

3. The fishing hook device of claim 1, wherein the first hook and the second hook comprise at least one barb.

4. The fishing hook device of claim 1, further comprising a first bait attached to the first hook and a second bait attached to the second hook.

5. The fishing hook device of claim 1, wherein the rail is substantially straight.

6. The fishing hook device of claim 1, wherein the rail comprises a bend in between the first side rail and the second side rail.
